(19) United States
(12) Patent Application Publication
(10) Pub. No.: US 2012/0018188 A1
(43) Pub. Date: Jan. 26, 2012

(54) Temporary Mounting Device For An Electrical Junction Box

(76) Inventor: Jack R. Kerr, JR., College Station, TX (US)

(21) Appl. No.: 13/191,399

(22) Filed: Jul. 26, 2011

Related U.S. Application Data
(60) Provisional application No. 61/367,516, filed on Jul. 26, 2010.

(51) Int. Cl. H02G 3/10

(52) U.S. Cl. 174/58

(57) ABSTRACT

An electrical junction box for use with carrying a load from a joist. The junction box includes a pancake housing and an upright side box compartment. The pancake housing is attached to the upright side box compartment to form an L-shaped configuration. The pancake housing also has an aperture for receiving a screw for attaching the junction box to the joist. The junction box also includes one or more tabs located on an upper surface of the pancake housing for temporarily retaining the junction box upon the joist. A screw is used for permanently affixing the junction box to the joist. The tabs may be integral to the junction box or removable.

### RELATED APPLICATIONS

This utility application claims the benefit of U.S. Provisional Patent Application Ser. No. 61/367,516 filed Jul. 26, 2010 by Jack R. Kerr, Jr., which is hereby incorporated by reference.

### BACKGROUND OF THE INVENTION

1. Field of the Invention

This invention relates to support assemblies. Specifically, and not by way of limitation, the present invention relates to a temporary mounting device for an electrical junction box.

2. Description of the Related Art

In construction of houses and buildings, it is quite common to have electrical boxes mounted in the walls or ceilings. These electrical boxes provide support and storage of various wiring devices, lighting fixtures, fans, and many other devices useful in a building. Electrical boxes also provide space for electrical connections between a wiring device or fixture and the wiring of the building. These electrical boxes are normally attached to one or more structural supports, such as joists or studs. Often the electrical boxes include brackets for directly attaching the electrical box to the support member, while other electrical boxes are attached to a hanger or other support assembly which extends between a pair of adjacent structural supports.

Oftentimes, these conventional electrical boxes are attached to an object, such as a stud in a wall by using fasteners (e.g., screws). The conventional electrical boxes or junction boxes often include holes through which a screw or other fastener is inserted for securing the electrical box to the supporting surface.

In addition, there are electrical boxes which are used for supporting a ceiling fan or other heavy light fixtures. FIG. 1 illustrates a front perspective view of an existing electrical junction box 10. FIG. 2 illustrates a side view of the junction box 10 of FIG. 1. The junction box includes an integral L-shaped configuration having a raised pancake housing 12 and an upright side box compartment 14. The housing includes a side wall 16, a knockout 18, and spaced slots 20 and 22 on a surface 24. The box compartment 14 includes a recess 26 and a front face 28 with an arc section 30 having an interior 32. The pancake housing 12 includes a removable cover 34. A screw 36 may be extended through an aperture 38 located on the surface 24. The screw 36 is used to affix the junction box 10 to a joist 50. The junction box may also be used to hold a light fixture or fan unit 52.

However, the task of affixing the junction box 10 to the supporting surface (e.g., joist 50) can be cumbersome. Oftentimes the junction box must be attached in an area above the installer's head. The installer must first locate and align the junction box in its correct intended position, while maintaining the correct position of the electrical box and simultaneously attempting to fasten a screw or hammer a nail into the support surface.

Thus, the installation of these existing junction boxes can be extremely difficult. Even experienced installers have tremendous difficulty when attempting to install the electrical box to the supporting surface when the electrical box is located in awkward overhead locations.

Therefore, it would be advantageous to have a mounting assembly which is easily installed, even in awkward overhead locations. It is an object of the present invention to provide such an apparatus.

### SUMMARY OF THE INVENTION

In one aspect, the present invention is directed to an electrical junction box for use with carrying a load from a joist. The junction box includes a pancake housing and an upright side box compartment. The pancake housing is attached to the upright side box compartment to form an L-shaped configuration. The pancake housing also has an aperture for receiving a screw for attaching the junction box to the joist. The junction box also includes one or more tabs located on an upper surface of the pancake housing for temporarily retaining the junction box upon the joist. A screw is used for permanently affixing the junction box to the joist. The tabs may be integral to the junction box or removable.

In another embodiment, the present invention is directed to an electrical junction box support system for use in carrying a load from a support. The system includes an electrical junction box having a pancake housing and an upright side box compartment. The pancake housing is attached to the upright side box compartment to form an L-shaped configuration. The system also includes a support such as a joist or stud. The electrical junction box is affixed to the support. One or more tabs are located on an upper surface of the pancake housing for temporarily retaining the junction box upon the support.

### BRIEF DESCRIPTION OF THE DRAWINGS

FIG. 1 (prior art) illustrates a front perspective view of an existing electrical junction box;

FIG. 2 (prior art) illustrates a side view of the junction box of FIG. 1;

FIG. 3 illustrates a front perspective view of an electrical junction box in the preferred embodiment of the present invention;

FIG. 4 illustrates a side view of the junction box of FIG. 3;

FIG. 5 is a front perspective view of the junction box;

FIG. 6 is a top view of the junction box;

FIG. 7 is an upper side view of the junction box;

FIG. 8 is a side view of the junction box showing the tabs; and

FIG. 9 is a second upper side view of the junction box.

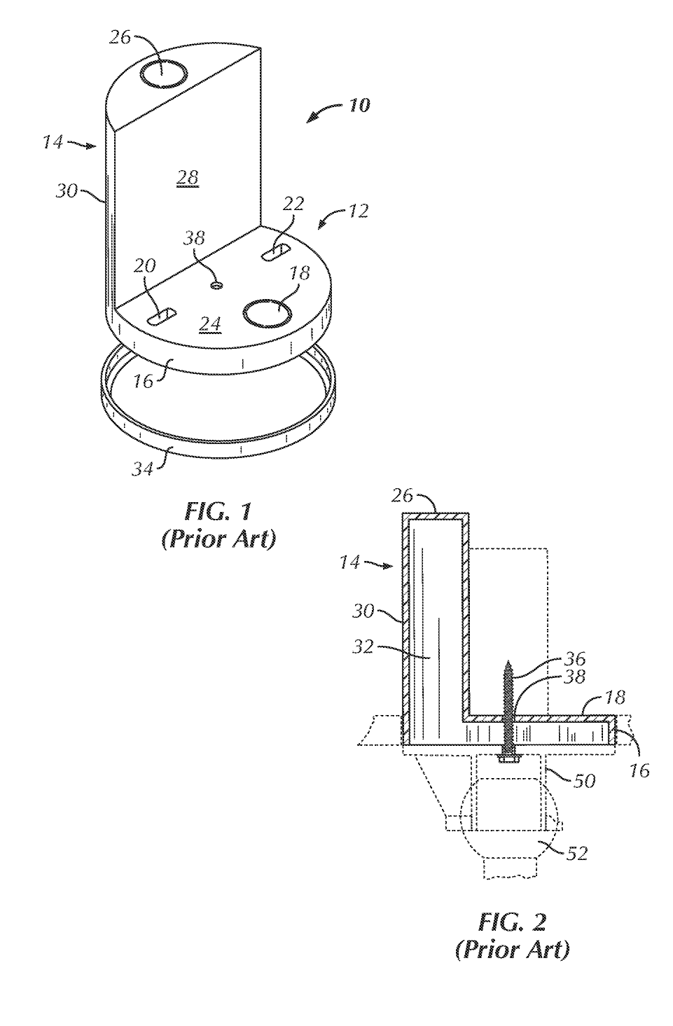

### DESCRIPTION OF THE INVENTION

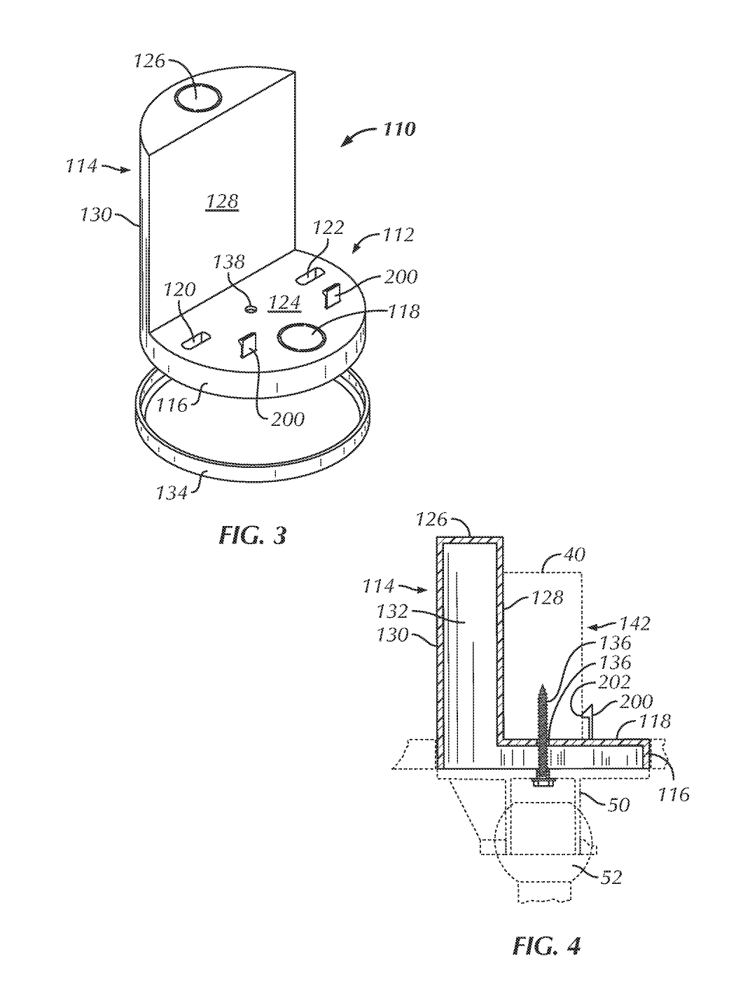

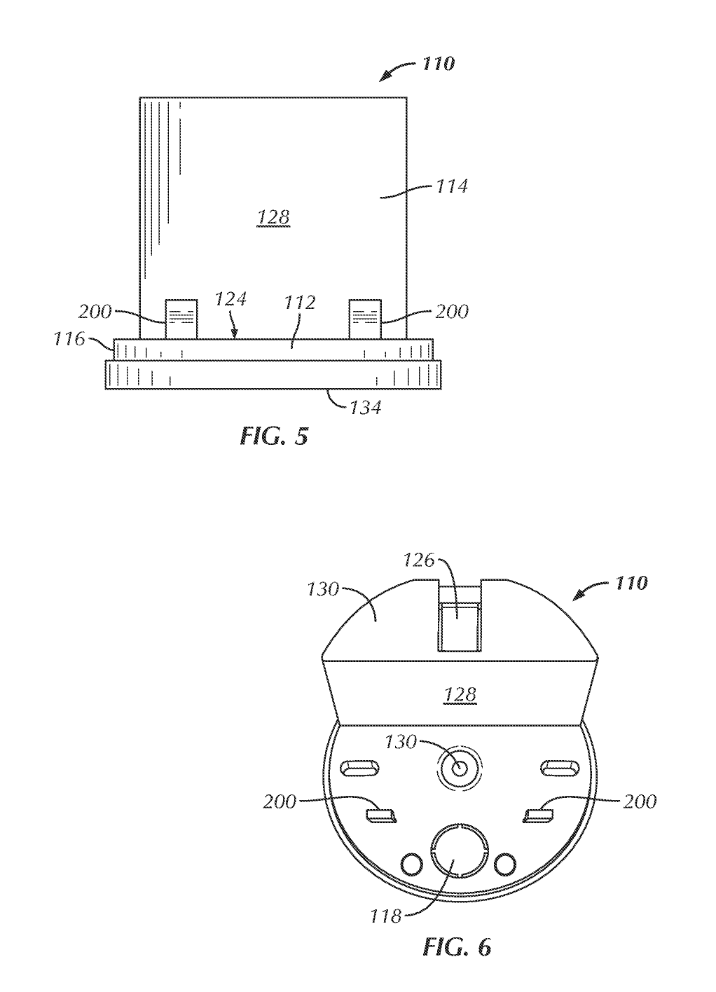

The present invention is a temporary mounting apparatus for an electrical junction box. FIG. 3 illustrates a front perspective view of an electrical junction box 110 in the preferred embodiment of the present invention. FIG. 4 illustrates a side view of the junction box 110 of FIG. 3. The junction box includes an integral L-shaped configuration having a raised pancake housing 112 and an upright side box compartment 114. The housing includes a side wall 116, a knockout 118, and spaced slots 120 and 122 on a surface 124. The box compartment 114 also includes a recess 126 and a front face 128 with an arc section 130 having an interior 132. The pancake housing 112 may include a removable cover 134. A screw 136 may be extended through an aperture 138 located on the surface 124. The screw 136 is used to affix the junction box 110 to a joist 50. The junction box may also be used to hold a light fixture or fan unit 52. The present invention also includes two or more tabs 200 for retaining the joist in the appropriate position. The tabs are positioned to provide sufficient room for the joist to be positioned directly adjacent the front face 128 of the junction box. The tabs directly contact the side surface 142 of the joist 50 with sufficient force to hold the junction box temporarily affixed to the joist while permanently affixing the junction box to the joist with the screw 138.

The tabs may be an integral part of the surface 124. In another embodiment of the present invention, the tabs may be removable from the surface 124. Preferably, the tabs are a hard plastic having a flange 202 for engaging the joist. In addition, in one embodiment, a single tab may be used to engage the joist. Additionally, although a joist is illustrated, the present invention may be affixed to any support, such as a stud or other immoveable object.

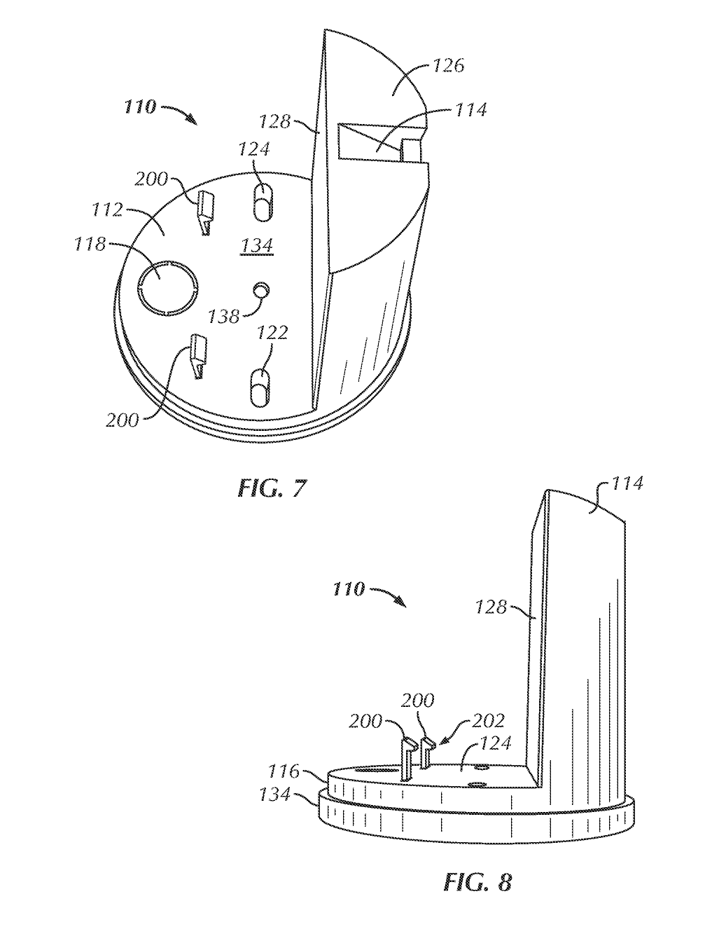

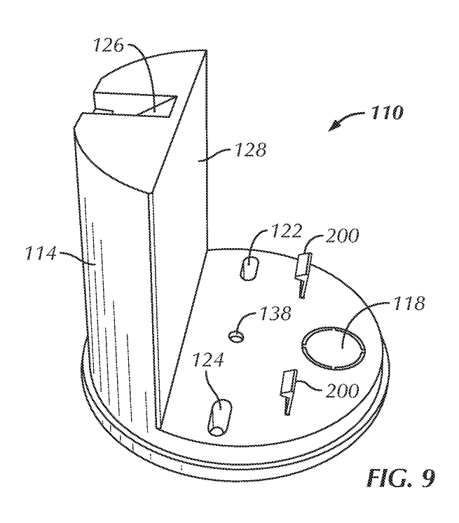

FIG. 5 is a front perspective view of the junction box 110. FIG. 6 is a top view of the junction box 110. FIG. 7 is an upper side view of the junction box. FIG. 8 is a side view of the junction box 110 showing the tabs 200. FIG. 9 is an upper side view of the junction box 110.

With reference to FIGS. 3-9, the operation of the present invention will now be explained. Prior to attaching the junction box 110 to the 40, the junction box is positioned adjacent the joist 50. The junction box is held in place by the tabs 200 which frictionally engage the side 142 of the joist. With the junction box properly positioned and held in place by the tabs 200, the installer does not need to hold the junction box in position. Thus, the installer may fasten the screw 136 into the joist 50 using both hands, thereby permanently affixing the junction box 110 to the joist 50. The tabs may remain in place or removed as desired by the installer after the installation is complete. Although the present invention is described in terms of a junction box, the present invention may be utilized on any support device, such as a mounting bracket, a junction box, etc.

The present invention provides many advantages over existing devices. The present invention provides a simple and efficient way of securing a junction box to any support surface. The present invention enables an installer to temporarily affix the junction box while fastening a screw or fastener to the joist or other support surface.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. An electrical junction box for use with carrying a load from a joist, the junction box comprising:
a pancake housing;
an upright side box compartment, the pancake housing attached to the upright side box compartment to form an L-shaped configuration; and
a tab located on an upper surface of the pancake housing for temporarily retaining the junction box upon the joist.

2. The electrical junction box according to claim 1 further comprising means for affixing the junction box to the joist.

3. The electrical junction box according to claim 2 wherein:
the pancake housing has an aperture; and
the means for affixing the junction box to the joist is a screw positioned within the aperture for attaching the junction box to the joist.

4. The electrical junction box according to claim 1 wherein the tab is integral to the pancake housing.

5. The electrical junction box according to claim 1 wherein the tab is removable from the pancake housing.

6. The electrical junction box according to claim 1 wherein the tab includes a flange for frictionally engaging the joist.

7. The electrical junction box according to claim 1 wherein the tab is constructed of a plastic material.

8. The electrical junction box according to claim 1 wherein the tab is positioned on the upper surface of the pancake housing to frictionally engage the joist while the joist is positioned against the upright side box compartment.

9. The electrical junction box according to claim 1 wherein the tab is a plurality of tabs.

10. An electrical junction box support system for use in carrying a load from a support, the system comprising:
an electrical junction box, the electrical junction box having a pancake housing and an upright side box compartment, the pancake housing attached to the upright side box compartment to form an L-shaped configuration;
a support;
means for affixing the electrical junction box to the support; and
a tab located on an upper surface of the pancake housing for temporarily retaining the junction box upon the support.

11. The system according to claim 10 wherein:
the pancake housing has an aperture; and
the means for affixing the junction box to the support is a screw positioned within the aperture for attaching the junction box to the support.

12. The system according to claim 10 wherein the tab is integral to the pancake housing.

13. The system according to claim 10 wherein the tab is removable from the pancake housing.

14. The system according to claim 10 wherein the tab includes a flange for frictionally engaging the support.

15. The system according to claim 10 wherein the tab is positioned to frictionally engage the support while the support is positioned against the upright side box compartment.

16. The system according to claim 10 wherein the tab is a plurality of tabs.

17. The system according to claim 10 wherein the support is a joist.

18. The system according to claim 10 wherein the support is a stud.
